(19) United States
(12) Patent Application Publication
(10) Pub. No.: US 2021/0153443 A1
(43) Pub. Date: May 27, 2021

(54) LEAF YARD NET

(71) Applicant: Ruth Schneider, Brecksville, OH (US)

(72) Inventor: Ruth Schneider, Brecksville, OH (US)

(21) Appl. No.: 17/103,189

(22) Filed: Nov. 24, 2020

Related U.S. Application Data
(60) Provisional application No. 62/940,347, filed on Nov. 26, 2019.

(51) Int. Cl. A01G 20/43

(52) U.S. Cl. CPC A01G 20/43

(57) ABSTRACT

A leaf yard net and a method for collecting leaves from a grassy area using the leaf yard net. The leaf yard net comprises a mesh configured to capture leaves when the leaf yard net is removed from the grassy area.

### RELATED APPLICATIONS

This application claims the benefit of 62/940,347 filed on Nov. 26, 2019. Which is herein incorporated by reference in its entirety.

### TECHNICAL FIELD

The present disclosure relates generally to yard leaf removal and more particularly to collecting leaves from grass using netting.

### BACKGROUND

In the autumn, deciduous trees lose their leaves and home owners often spend multiple hours (depending on the size and number of trees) to remove fallen leaves from their lawns before winter. If the leaves are not removed, then the underlying grass may be killed.

### SUMMARY

The present invention provides a leaf yard net and a method for collecting leaves from a grassy area using the leaf yard net. The leaf yard net comprises a mesh configured to capture leaves when the leaf yard net is removed from the grassy area.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is an image of an exemplary leaf yard net.

FIG. 2 is an image of the leaf yard net of FIG. 1 laid out under a tree.

FIGS. 3-5 are images of the leaf yard net of FIGS. 1 and 2 being used to pick up leaves.

FIGS. 6 and 7 are images of another exemplary leaf yard net.

FIGS. 8-10 are images of the leaf yard net of FIGS. 6 and 7 laid out under a tree and being used to pick up leaves.

FIG. 11 is an exemplary diagram of a leaf yard net including fixing structures.

FIG. 12 is an exemplary diagram of a leaf yard net having a circular shape.

FIG. 13 is a flow diagram of a method for collecting leaves using the leaf yard net.

### DETAILED DESCRIPTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

The present invention provides a leaf yard net and a method for collecting leaves from a grassy area using the leaf yard net. The leaf yard net comprises a mesh configured to capture leaves when the leaf yard net is removed from the grassy area.

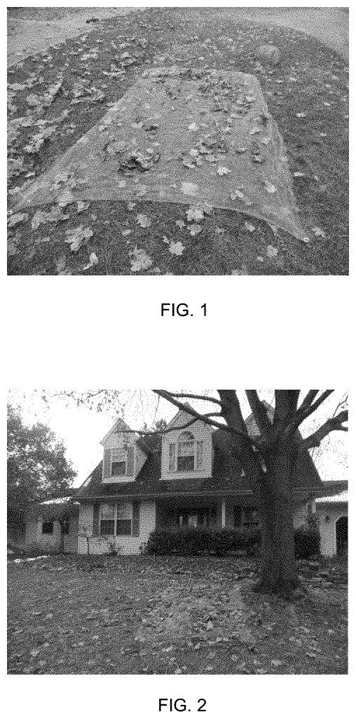

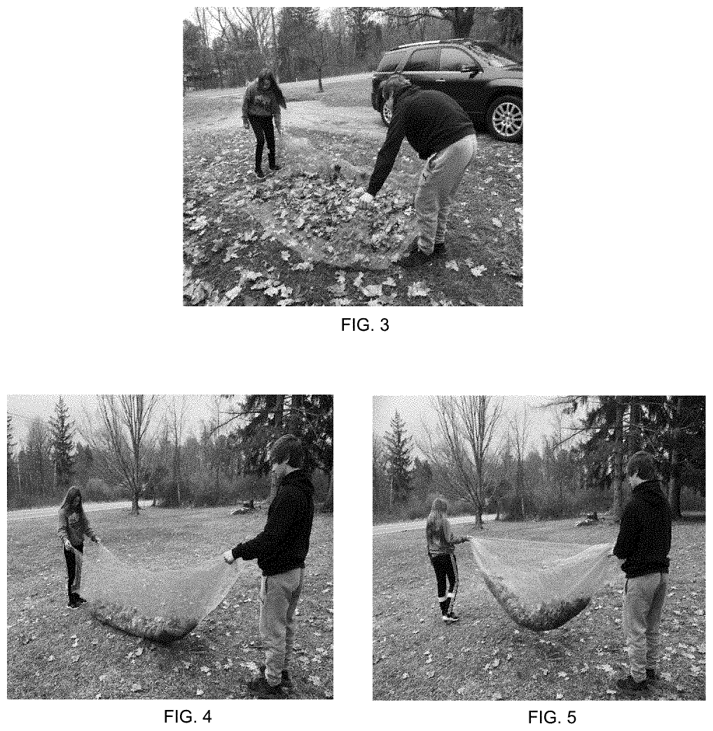

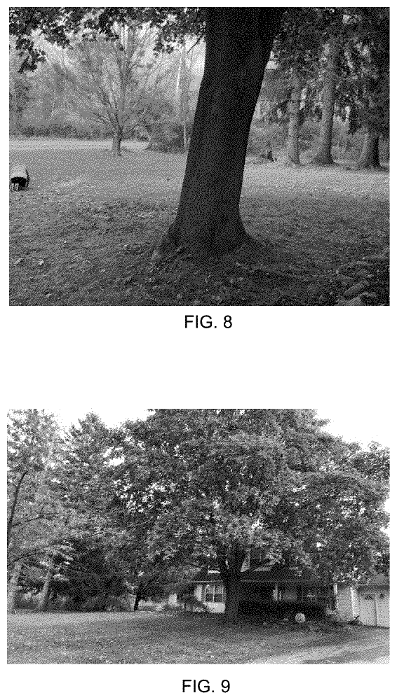

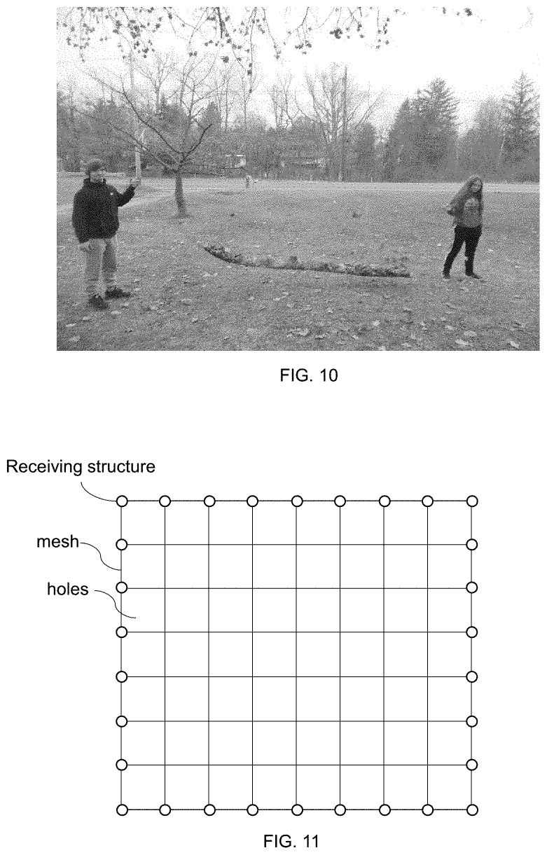

Turning to FIGS. 1-10, a leaf yard net for collecting leaves from a grassy area is shown. The leaf yard net includes a mesh comprising an interlaced structure having holes (also referred to as openings). The leaf yard net is placed in a yard (e.g., a grassy area) and used to collect leaves, pine needles, crabapples, or any other items that fall from the tree. The leaf yard net may be placed in the grassy area before leaves begin to fall off of the tree such that any falling leaves landing in the grassy area are located on top of the leaf yard net. The leaf yard net saves time from raking or blowing leaves to clear the grassy area, because the leaf yard net may be removed from the grassy area, capturing the leaves as the leaf yard net is removed.

The mesh of the leaf yard net may be made of any suitable material. For example, the netting may be made of plastic or a fibrous material (such as rope).

The mesh of the leaf yard net may also have any suitable color. For example, the mesh may be green, black, brown, or camouflage in color so that the mesh (also referring to as netting) blends in with the grass when installed.

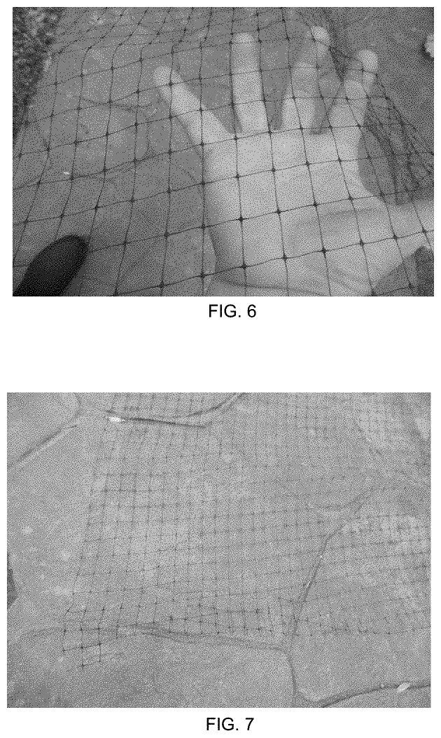

The holes of the mesh may have any suitable size. For example, the holes of the mesh may be between 0.25 inch and 2 inches wide. A size of the holes in the mesh may be chosen based on a type of tree that the leaf yard net will be placed near. For example, for trees with larger leaves, the leaf yard net may have a hole width of 3 inches. Conversely, for trees with smaller leaves or for trees that drop acorns, mesh may have a hole width of 1 inch (or smaller) as shown in FIG. 6.

The leaf yard net may include ground fasteners configured to engage with the mesh and a ground of the grassy area and to maintain a position of the leaf yard net relative to the ground. For example, the ground fasteners may comprise stakes. The ground fasteners may be integral to the mesh (for example, the mesh and the ground fasteners may be attached to one another). Alternatively, the ground fasteners may be separate and distinct from the mesh.

As shown in FIG. 11, the leaf yard net may include receiving structures configured to interact with the ground fasteners. When the ground fasteners are pushed into the ground, the receiving structures interact with the ground fasteners and maintain a position of the mesh relative to the ground. For example, the receiving structures may comprise grommets. Alternatively or additionally, the receiving structures may comprise the mesh itself. For example, the ground fasteners may have a body including an arm portion. The arm portion may be shaped to hook onto the mesh when the body of the ground fastener is inserted into the ground.

The receiving structures may be located at corners of the leaf yard net. Alternatively or additionally, the receiving structures may be further located along edges of the leaf yard net between the corners.

As shown in FIGS. 7 and 11, the leaf yard net may have a square or rectangular shape. For example, the leaf yard net may come in any suitable size, such as 10×12 feet, 16×20 feet, 20×20 feet, or 20×25 feet.

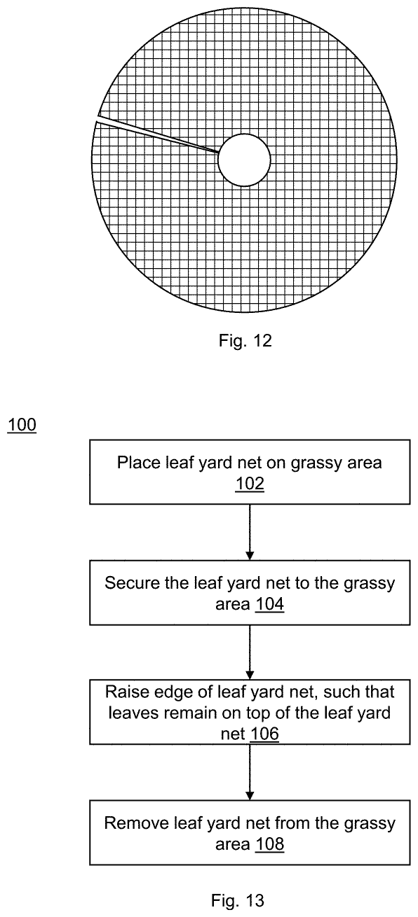

Alternatively, as shown in FIG. 12, the leaf yard net may have an outer circular edge, an inner circular edge opposite the outer circular edge, and an opening extending between the outer circular edge and the inner circular edge. The opening may be configured to allow for the leaf yard net to be positioned around a base of a tree with the inner circular edge positioned adjacent a base of the tree.

The leaf yard net may include structures for maintaining a position of the leaf yard net relative to the grassy area. For example, the leaf yard net may include grommets for interacting with a fastener (e.g., a stake) for fastening the leaf yard net to the ground of the grassy area.

The leaf yard net may also include self fasteners (e.g., snaps or buttons) configured to engage with one another, such that the mesh forms a pocket for holding the leaves. Additionally, the self fasteners may be used to connect multiple leaf yard nets together. For example, as shown in FIG. 11, the mesh may have a first edge opposite a second edge. The first edge may include a first type of self fastener and the second edge may include a second type of self fastener. The first type of self fasteners may be configured to fixedly engage with the second type of self fasteners. In this way, when the first type of self fasteners of the first edge and the second type of self fasteners of the second edge are engaged, a pocket may be formed between the first edge and the second edge.

Turning to FIG. 13, a method 100 of collecting leaves from a grassy area using a leaf yard net comprising a mesh including holes is shown. In process block 102, the leaf yard net is placed on the grassy area to cover the grassy area. In process block 104, the leaf yard net is secured to the grassy area. When leaves have landed on the grassy area, the leaf yard net is removed. The leaf yard net is removed by (1) raising at least one edge of the leaf yard net, such that leaves remain on top of the leaf yard net (106) and (2) removing the leaf yard net from the grassy area (108).

In one embodiment, the leaf yard net may be placed over or onto a surface of water (such as a pool or pond) for capturing leaves. In another embodiment, the leaf yard net is placed over landscaping, such as mulch, plants (e.g., bushes), etc. In both of these embodiments, as leaves fall onto the leaf yard net, the leaf yard net may be removed as described above regarding the grassy area.

Securing the leaf yard net to the grassy area may include moving the leaf yard net towards a ground of the grassy area, such that grass of the grassy area extends through the holes of the leaf yard net and the mesh of the leaf yard net lies below a surface formed by tips of the grass. Alternatively or additionally, securing the leaf yard net to the grassy area may include pushing a fastener engaged with the mesh of the leaf yard net into the ground of the leaf yard net.

The leaf yard net may be secured in such a manner that the mesh of the leaf yard net lies adjacent a ground of the grassy area, such that the grass may be cut using a lawn mower without interference by the leaf yard net. In this way, the leaf yard net may be positioned in the grassy area for an extended period of time (e.g., months) before being removed to collected leaves that have fallen on the grassy area.

Pushing the fastener into the ground of the leaf yard net may include pushing integrated fasteners attached to the leaf yard net into the ground. Alternatively, pushing the fastener into the ground may comprise positioning separate distinct fasteners relative to the mesh of the leaf yard net, such that, when the fasteners are pushed into the ground, a portion of the fasteners interacts with the mesh of the leaf yard net and maintain a position of the mesh relative to the ground.

The raising of the at least one edge of the leaf yard net may include raising adjacent edges of the leaf yard net and fastening the adjacent edges of the leaf yard net to one another, such that the mesh of the leaf yard net forms a pocket for holding the leaves on top of the leaf yard net.

The leaf yard net may also include a raising structure configured to raise at least one edge of the leaf yard net. For example, the raised edge may be used to capture leaves that are blowing in the wind. The raising structure may comprise a pole or similar structure. The raising structure may raise the edge by an adjustable height (e.g., 1 foot, 2 foot, 3 foot, etc.).

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of collecting leaves from a grassy area using a leaf yard net comprising a mesh including holes, the method comprising:
placing the leaf yard net on the grassy area;
expanding the leaf yard net to cover the grassy area;
securing the leaf yard net to the grassy area; and
when leaves have landed on the grassy area, removing the leaf yard net by:
raising at least one edge of the leaf yard net, such that leaves remain on top of the leaf yard net; and
removing the leaf yard net from the grassy area.

2. The method of claim 1, wherein the securing of the leaf yard net to the grassy area comprises at least one of:
moving the leaf yard net towards a ground of the grassy area such that:
grass of the grassy area extends through the holes of the leaf yard net; and
the mesh of the leaf yard net lies below a surface formed by tips of the grass; or
pushing a fastener engaged with the mesh of the leaf yard net into the ground of the leaf yard net.

3. The method of claim 2, wherein the leaf yard net is secured in such a manner that the mesh of the leaf yard net lies adjacent a ground of the grassy area, such that the grass may be cut using a lawn mower without interference by the leaf yard net.

4. The method of claim 2, wherein the pushing of the fastener into the ground of the leaf yard net comprises at least one of:
pushing integrated fasteners attached to the leaf yard net into the ground;
positioning separate distinct fasteners relative to the mesh of the leaf yard net, such that:
when the fasteners are pushed into the ground, a portion of the fasteners interacts with the mesh of the leaf yard net and maintains a position of the mesh relative to the ground.

5. The method of any of the preceding claims, wherein the raising of the at least one edge of the leaf yard net comprises:
raising adjacent edges of the leaf yard net;
fastening the adjacent edges of the leaf yard net to one another, such that the mesh of the leaf yard net forms a pocket for holding the leaves on top of the leaf yard net.

6. A leaf yard net for collecting leaves from a grassy area, the leaf yard net comprising:
a mesh comprising an interlaced structure having holes between the interlaced structure.

7. The leaf yard net of claim 6, wherein the holes are between 1 inch and 3 inches wide.

8. The leaf yard net of claim 6, further comprising ground fasteners configured to engage with the mesh and a ground of the grassy area.

9. The leaf yard net of claim 8, wherein:
the ground fasteners are integral to the mesh or the ground fasteners are separate and distinct from the mesh.

10. The leaf yard net of claim 8, further comprising receiving structures, wherein:
when the ground fasteners are pushed into the ground, the receiving structures are configured to interact with the ground fasteners and maintain a position of the mesh relative to the ground.

11. The leaf yard net of claim 10, wherein the receiving structures comprise grommets.

12. The leaf yard net of claim 10, wherein the receiving structures are located at corners of the leaf yard net.

13. The leaf yard net of claim 12, wherein the receiving structures are further located along edges of the leaf yard net between the corners.

14. The leaf yard net of claim 6, wherein the leaf yard net has a square or rectangular shape.

15. The leaf yard net of claim 6, further comprising:
an outer circular edge;
an inner circular edge opposite the outer circular edge; and
an opening (1) extending between the outer circular edge and the inner circular edge and (2) configured to allow the leaf yard net to be positioned around a base of a tree with the inner circular edge positioned adjacent a base of the tree.

16. The leaf yard net of claim 6, further comprising self fasteners configured to engage with one another, such that the mesh forms a pocket for holding the leaves.

17. The leaf yard net of claim 16, wherein:
the mesh has a first edge opposite a second edge;
the first edge includes a first type of self fasteners;
the second edge includes a second type of self fasteners;
the first type of self fasteners are configured to engage with the second type of self fasteners, such that:
when the first type of self fasteners of the first edge and the second type of self fasteners of the second edge are engaged, the pocket is formed between the first edge and the second edge.
